(19) United States
(12) Patent Application Publication
(10) Pub. No.: US 2016/0153295 A1
(43) Pub. Date: Jun. 2, 2016

(54) COMPOSITE VANE FOR A TURBINE ENGINE

(71) Applicants: SAFRAN, Paris (FR); SNECMA, Paris (FR)

(72) Inventors: Sebastien PAUTARD, Palaiseau (FR); Maxime BRIEND, Massy (FR)

(73) Assignees: SAFRAN, Paris (FR); SNECMA, Paris (FR)

(21) Appl. No.: 14/526,754

(22) Filed: Oct. 29, 2014

(30) Foreign Application Priority Data
Oct. 31, 2013 (FR) 13 60655

(51) Int. Cl. F01D 9/04

(52) U.S. Cl. CPC F01D 9/041; F05D 2220/30; F05D 2230/30; F05D 2240/12; F05D 2240/80; F05D 2300/10; F05D 2300/603

(57) ABSTRACT

A composite vane for a turbine engine, the vane having a pressure side face (12) and a suction side face (14) that define the aerodynamic profile of the vane, the vane (10) comprising: a metallic core (20) forming the pressure side face (12) or the suction side face (14) of the vane; and an organic matrix (30) associated with the metallic core (20).

### TECHNICAL FIELD

The present invention relates to a composite vane for a turbine engine, and to methods of fabricating the vane.

Such a vane may be fitted to any type of terrestrial or aviation turbine engine, and for example to an airplane turbojet or to a helicopter turboshaft engine. In particular, it may be an outlet guide vane (OGV), an inlet guide vane (IGV), or a variable stator vane (VSV).

### BACKGROUND

In the field of turbine engines, composite vanes are preferred over metallic vanes in certain applications. In particular in aviation turbine engines, composite vanes are appreciated, specifically because of their light weight.

Such composite vanes may be fabricated in various ways. For example, certain composite vanes are fabricated by draping a woven fabric that is pre-impregnated with resin. Others are fabricated by three-dimensionally weaving a reinforcing structure out of carbon or plastics fibers and by vacuum injection of a resin, e.g. an epoxy, bismaleimide, or cyanate-ester resin into the woven structure (see for example patent document FR 2 892 339).

Nevertheless, the costs and/or the time required for fabricating known composite vanes are often considered as being excessive. Furthermore, it can be difficult to fabricate vanes of certain shapes by means of known methods. This applies in particular to vanes of small size or of complex shape.

There therefore exists a need for a novel type of composite vane and for associated novel methods of fabrication.

### GENERAL SUMMARY

The present description relates to a composite vane for a turbine engine having a pressure side face and a suction side face that define the aerodynamic profile of the vane.

The vane has a metallic core forming the pressure side face and/or the suction side face of the vane, and an organic matrix associated with the metallic core.

The metallic core of the composite vane may thus form the pressure side face of the vane, the suction side face, or both faces. The selection between pressure side and suction side may be made as a function of problems of erosion or abrasion, as a function of mechanical stresses to which the vane is subjected in operation, and/or as a function of the required aerodynamic profile and feasibility conditions for making it. Likewise, the thickness of the metallic core (which may vary from one portion to another of the metallic core) may be selected as a function of the above-mentioned parameters. For example, a core of greater thickness improves the stiffness of the vane.

The metallic core may form at least one of the pressure side and suction faces in full, thereby serving to improve the stiffness of the vane and its aeromechanical behavior. This also makes it possible to simplify fabrication of the vane. For example, when the vane is formed by injecting the organic matrix onto the metallic core, the positioning of the core in the injection mold is facilitated. Furthermore, this avoids any need to have a join plane in the injection mold in the face under consideration, thus reducing any risk of defects in this face.

The term “metallic” core is used to mean a part that is made of metal, of metal alloy, or of cermet. For example, the metallic core may be made of titanium, of aluminum, of steel (stainless or otherwise), of superalloy based on nickel or chromium (e.g. the superalloy sold under the trademark “Inconel”), or of metallic glass.

The pressure side and suction side faces of the vane may extend between a leading edge and a trailing edge.

In certain embodiments, the metallic core also forms the leading edge of the vane and/or the trailing edge of the vane. Once more, the leading edge and/or the trailing edge may be selected as a function of the above-mentioned parameters, and in particular of mechanical stresses to which the vane is subjected in operation and as a function of fabrication problems (thickness of portions, movements of tooling, join planes, etc.). For example, the metallic core may form the leading edge of the vane and at least a portion of its pressure side or suction side face; it may also form the trailing edge of the vane and at least a portion of its pressure side or suction side face; or it may form the leading edge and the trailing edge of the vane together with one of its pressure side or suction side faces in full.

In other embodiments, on the contrary, the metallic core forms neither the leading edge nor the trailing edge of the vane. Under such circumstances, the leading edge or the trailing edge of the vane may be formed by the organic matrix. This may be applicable, for example, for vanes of small size and small thickness.

The fact that the metallic core forms the leading edge of the vane and/or the trailing edge of the vane serves to protect the edge(s) in operation. Such protection is particularly useful for the leading edge which is the more exposed to impacts. Thus, because of the metallic core, there is no need to fasten additional protection on the leading edge of the vane. This solution thus presents an advantage over previously known fabrication methods in which a U-shaped reinforcing edge is adhesively bonded along the leading edge of a vane in order to reinforce it and protect it against impacts (see for example patent document FR 2 965 202).

In certain embodiments, the organic matrix forms at least a portion of the suction side face or of the pressure side face of the vane, it being understood that when the metallic core forms the pressure side face, the organic matrix forms the suction side face of the vane, at least in part, and vice versa. In addition, if the metallic core does not form the pressure side (or suction side) face in full, the composite matrix forms the remaining portion of that face.

In certain embodiments, the vane includes a platform and the platform may be formed by the organic matrix. The vane may have one or two platforms depending on its application. Such a platform is adjacent to the outer and/or inner end of the suction side and pressure side faces of the vane and co-operates with those faces to define a fluid flow passage surrounding the vane.

In the present description, the term “airfoil” is used to designate the portion of the vane that defines its lift-providing surface, which portion is to be located in the flow of fluid passing through the turbine engine. The pressure side and suction side faces of the vane thus form parts of the airfoil. When the vane has an inner platform, the platform is situated at the base of the airfoil and extends transversely relative to the airfoil.

In certain embodiments, the organic matrix is based on thermoplastic or thermosetting polymer(s). For example, the organic matrix may be made using a thermosetting resin based on epoxy, polybismaleimide, or cyanate ester polymer, or on the basis of a thermoplastic resin based on polyaryletherketone (PAEK—including PEEK, PEKK, PEK, PEKEKK, PEKKEK, etc.), polyethylenimine (PEI), poly-phenylene sulfide (PPS), polyimide (PI), or resulting from a mixture of the above-specified polymers. Where appropriate, the resin used for the matrix may incorporate reinforcement constituted by a filler. Such a filler may be in the form of long or short fibers, cut fibers, beads, flakes, etc. For example, it may comprise glass fibers or carbon fibers. On setting, the resin forms the organic matrix.

The present description also relates to a method of fabricating a composite vane of the above-specified type, in which a resin is injected to constitute the organic matrix on the metallic core.

In an implementation, the metallic core is positioned in an injection mold and the resin is injected into the mold.

The organic matrix may be injected onto the metallic core in one or more steps. The resin may also be injected into the mold by bi-injection or tri-injection.

The injected resin may include fillers, as mentioned above.

When it is desired to fabricate a vane with one or two platforms, such a platform may be overmolded on a previously formed first assembly that includes the metallic core. For this purpose, a resin is injected onto the first assembly, the resin forming said platform on setting.

In certain implementations, the resin is injected onto the metallic core using an injection-compression technique. The principle of that technique is to inject the resin into a mold that is partially closed. After or during filling of the mold cavity, the resin is compressed by closing the mold or by moving movable portions inside the mold. For example, the compressibility of the resin used may lie in the range about 5% to about 15%. The injection-compression technique makes it possible to obtain uniform pressure over the entire molded part, and for example to mold vanes with zones that are very fine, without warping and without internal stresses. The injection-compression also makes it possible to form a vane with one or two platforms in a single injection-compression step.

In another implementation, the method of fabricating the vane comprises a step of extruding the organic matrix onto the metallic core. For example, it is possible to provide a metallic section member corresponding to the metallic core and to extrude the organic matrix onto the section member. Where appropriate, the extruded assembly as formed in that way is then cut into segments of desired length, these segments forming vane airfoils. Thereafter, it is possible to overmold one or two platforms onto each airfoil, e.g. by injection resin onto the airfoil, the resin forming the platform(s) by setting.

Since fabricating the airfoil by extrusion does not make it possible to obtain an airfoil that is twisted about its main axis, it is possible to perform a stamping operation after the extrusion step in order to shape (e.g. twist) the airfoil.

In certain implementations, a bonding primer is used between the metallic core and the organic matrix in order to improve bonding between those two parts and thus improve the cohesion of the vane. The primer may also serve to mitigate galvanic couple problems that may arise depending on the pairs of materials used.

In order to improve the cohesion of the vane, it is possible to form portions in relief on the metallic core.

For example, protuberances (e.g. undercuts) and/or cavities (e.g. grooves) may be formed on/in the face of the metallic core that is to come into contact with the organic matrix (i.e. the face opposite from the face of the core that forms the pressure side or suction side face of the vane). Such portions in relief serve to improve adhesion between the core and the matrix.

The characteristics and advantages of the proposed composite vane, and of others, appear on reading the following detailed description of embodiments. This detailed description makes reference to the accompanying drawings.

### BRIEF DESCRIPTION OF THE DRAWINGS

The accompanying drawings are diagrammatic and they are not to scale, since they seek above all to illustrate the principles of the invention.

In the drawings, from one figure to another, elements (or portions of an element) that are identical or analogous are identified by the same reference signs.

FIG. 1 shows an example of a composite vane for a turbine engine comprising a metallic core and an organic matrix.

FIG. 2 is a detail view of the metallic core of the FIG. 1 vane.

FIGS. 3 and 4 show other examples of composite vanes.

FIG. 5 is a detail view of the metallic core of the FIG. 4 vane.

FIGS. 6 and 7 show other examples of composite vanes.

### DETAILED DESCRIPTION OF EMBODIMENTS

Embodiments are described in detail below with reference to the accompanying drawings. These embodiments show the characteristics and advantages of the invention. It should nevertheless be understood that the invention is not limited to these embodiments.

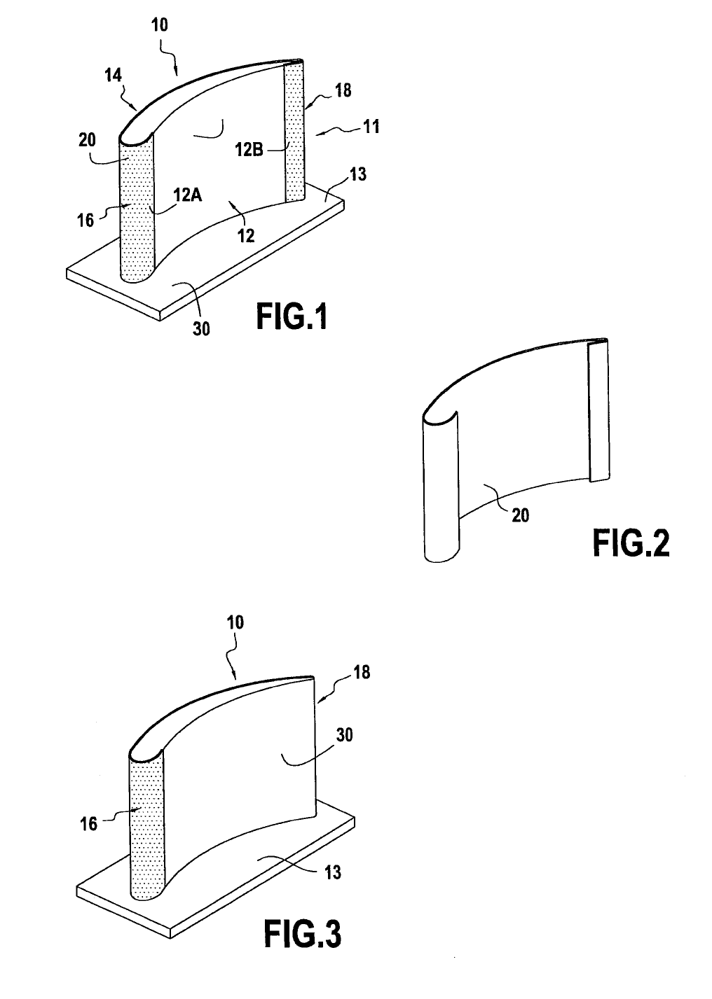

FIG. 1 shows a composite vane 10 of a turbine engine. The vane comprises an airfoil portion or airfoil 11 and a platform 13 at the base of the airfoil 11. The platform 13 extends transversely to the airfoil 11. The vane 10, and the more precisely the airfoil 11, has a pressure side face 12 and a suction side face 14, which define the aerodynamic profile of the vane. The pressure side and suction side faces 12 and 14 extend (in the fluid flow direction) from a leading edge 16 to a trailing edge 18 of the vane. At the base of the pressure side and suction faces 12 and 14, the vane has a platform 13.

The vane 10 comprises a core 20 and a matrix 30 associated with the core 20. The core 20 is metallic and the matrix 30 is organic, e.g. being made of thermoplastic or thermosetting polymer(s).

The core 20 is shown on its own in FIG. 2. It forms and defines the entire suction side face 14 of the vane 10. The core 20 also forms or defines the entire leading edge 20 and the entire trailing edge 18 of the vane. The core 20 may also form or define part of the pressure side face of the vane. In the example of FIG. 1, the core 20 forms a portion 12A of the pressure side face beside the leading edge 16 and a portion 12B of the pressure side face beside the trailing edge 18.

Thus, in this embodiment, following the circumferential direction of the vane 10, the core 20 extends over the entire suction side, passes over the leading and trailing edges 16 and 18, and extends on the pressure side over two portions situated in the proximity of the leading and training edges 16 and 18 respectively. In the height direction of the vane 10, the core 20 extends over the full height of the vane 10. The core 20 thus runs along the full height of the leading and trailing edges 16 and 18.

As shown in FIG. 2, the core 20 is generally in the form of a section member having a profile in cross-section that is generally C-shaped (or U-shaped), the base of the C-shape corresponding to the suction side face of the vane and the branches of the C-shape being folded around the leading and trailing edges 16 and 18 of the vane 10. In cross-section, the matrix 30 lies inside the C-shaped profile.

In the example of FIG. 1, the matrix 30 is situated inside the cavity defined by the metallic core, on its side opposite from the suction side face 14. The matrix 30 thus forms the central portion of the vane and forms part of the pressure side face 12 of the vane (i.e. the parts between the portions 12A and 12B). The matrix 30 also forms the platform 13 of the vane 10.

The matrix 30 and the core 20 are bonded together. Typically, this bonding is the result of the method used for fabricating the vane. This applies in particular when the matrix 30 is injected or extruded onto the core 20, as described above.

FIG. 3 shows another embodiment of a composite vane 10. This vane 10 differs from the vane of FIG. 1 solely in the shape of its metallic core 20. In this embodiment, the core 20 extends over the entire suction side 14 and stops at the trailing edge 18. The core 20 therefore does not form a portion comparable to the portion 12B of FIG. 1.

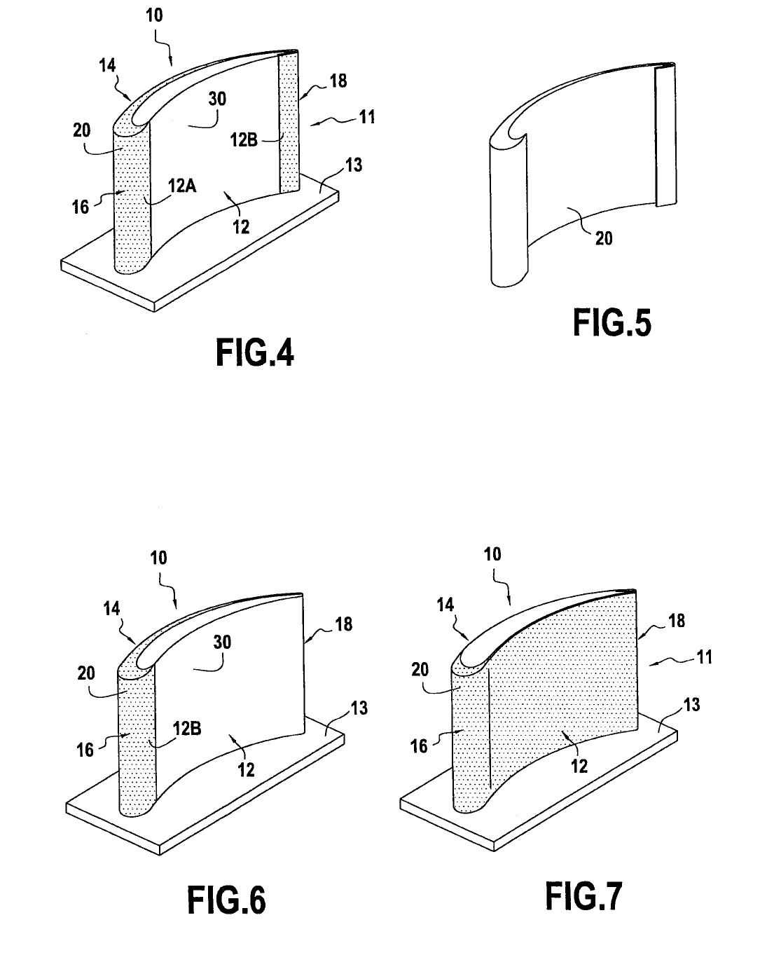

FIG. 4 shows another embodiment of a composite vane 10. This vane 10 differs from the vane of FIG. 1 solely in that the core 20 is of varying thickness. The core 20 is shown on its own in FIG. 5. The thickness of the core 20 is relatively large, possibly at a maximum, in the vicinity of the leading edge 16, and relatively small, possibly at a minimum, at the trailing edge 18. The large thickness of the core 20 at the leading edge 16 serves to impart stiffness and to increase mechanical strength in the region of the leading edge, this region being generally more exposed to mechanical stresses and to impacts. In this embodiment, the thickness of the core 20 decreases progressively going from the leading edge 16 towards the trailing edge 18.

FIG. 6 shows another embodiment of a composite vane 10. This vane 10 differs from the vane of FIG. 4 solely in the shape of the metallic core 20. In this embodiment, the metallic core 20 stops at the trailing edge 18 of the vane 10. The difference between the vanes of FIGS. 4 and 6 is thus analogous to the difference between the vanes of FIGS. 1 and 3.

FIG. 7 shows another embodiment of a composite vane 10. This vane 10 differs from the vane of FIG. 4 by the fact that the core 20 no longer forms all of the suction side face 14, but forms all of the pressure side face 12.

Thus, in the embodiment of FIG. 7, in the circumferential direction of the vane 10, the core 20 extends over the entire pressure side, passing over the leading and trailing edges 16 and 18, and extending on the suction side over two portions situated in the proximities of the leading and trailing edges 16 and 18 respectively. In the height direction of the vane 10, the core 20 extends over the full height of the vane 10. The core 20 thus runs along the leading and trailing edges 16 and 18 over their full height.

The embodiments described in the present description are given purely by way of non-limiting illustration, and in the light of this description, a person skilled in the art can easily modify these embodiments or envisage others, while remaining within the scope of the invention.

Furthermore, the various characteristics of these embodiments may be used on their own or in combination with one another. When they are combined, these characteristics may be combined as described above or in other ways, the invention not being limited to the specific combinations described in the present description. In particular, unless specified to the contrary, a characteristic described with reference to one particular implementation may be applied in analogous manner to another implementation.

1. A composite vane for a turbine engine, the vane having a pressure side face and a suction side face that define the aerodynamic profile of the vane, the vane comprising:
a metallic core forming the pressure side face or the suction side face of the vane; and
an organic matrix associated with the metallic core;
Wherein the vane includes at least one platform, the platform being formed by the organic matrix.

2. A composite vane according to claim 1, wherein the pressure side and suction side faces extend between a leading edge and a trailing edge of the vane, and wherein the metallic core also forms the leading edge and/or the trailing edge of the vane.

3. A composite vane according to claim 1, wherein the organic matrix forms at least part of the suction side face or of the pressure side face of the vane.

4. A composite vane according to claim 1, wherein the organic matrix is based on thermoplastic or thermosetting polymer(s).

5. A fabrication method for fabricating a composite vane according to claim 1, wherein a resin constituting the organic matrix is injected onto the metallic core, and wherein a vane platform is made by overmolding the platform on the injected assembly including the metallic core by injecting a resin onto said assembly.

6. A fabrication method for fabricating a composite vane according to claim 1, including a step of extruding the organic matrix onto the metallic core, and wherein a vane platform is made by overmolding the platform on the extruded assembly including the metallic core by injecting a resin onto said assembly.

7. A fabrication method according to claim 5, wherein the resin is injected on the metallic core using an injection-compression technique.

8. A fabrication method according to claim 5, wherein the resin includes fillers.
